(19) United States
(12) Patent Application Publication
(10) Pub. No.: US 2018/0025322 A1
(43) Pub. Date: Jan. 25, 2018

(54) SKILL-BASED RECOMMENDATION OF EVENTS TO USERS

(71) Applicant: LinkedIn Corporation, Mountain View, CA (US)

(72) Inventors: Andranik Kurghinyan, Mountain View, CA (US); Austin Q. Lu, Sunnyvale, CA (US)

(73) Assignee: LinkedIn Corporation, Mountain View, CA (US)

(21) Appl. No.: 15/215,251

(22) Filed: Jul. 20, 2016

(51) Int. Cl. G06Q 10/10

(52) U.S. Cl. CPC G06Q 10/1053; G06Q 50/01

(57) ABSTRACT

The disclosed embodiments provide a system for performing skill-based recommendation of events. During operation, the system obtains member attributes for a member of an online professional network. Next, the system matches the location of the member and one or more of the member attributes to event attributes of a set of events. The system then uses the member attributes and the event attributes to calculate a set of relevance scores representing a relevance of the events to the member. Finally, the system uses the set of relevance scores to output one or more of the events as recommendations to the member.

### BACKGROUND

### Field

The disclosed embodiments relate to user recommendations. More specifically, the disclosed embodiments relate to techniques for performing skill-based recommendation of events to users.

### Related Art

Social networks may include nodes representing individuals and/or organizations, along with links between pairs of nodes that represent different types and/or levels of social familiarity between the nodes. For example, two nodes in a social network may be connected as friends, acquaintances, family members, classmates, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate activities related to business, sales, recruiting, networking, professional growth, and/or career development. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for performing skill-based recommendation of events to users in accordance with the disclosed embodiments.

FIG. 3 shows an exemplary screenshot in accordance with the disclosed embodiments.

FIG. 4 shows a flowchart illustrating the process of performing skill-based recommendation of events in accordance with the disclosed embodiments.

FIG. 5 shows a flowchart illustrating the process of outputting events as recommendations to a member of an online professional network in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

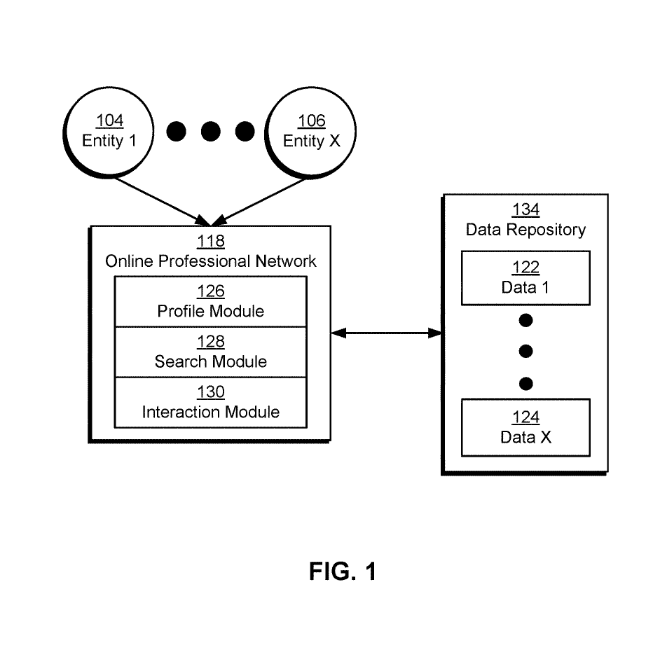

The disclosed embodiments provide a method, apparatus, and system for improving use of a social network. As shown in FIG. 1, the social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. The profile module may also allow the entities to view the profiles of other entities in the online professional network.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, experience level, etc.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or content feed that provides the latest postings, articles, and/or updates from the entities' connections and/or groups to the entities. Similarly, the online professional network may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing data repository 134.

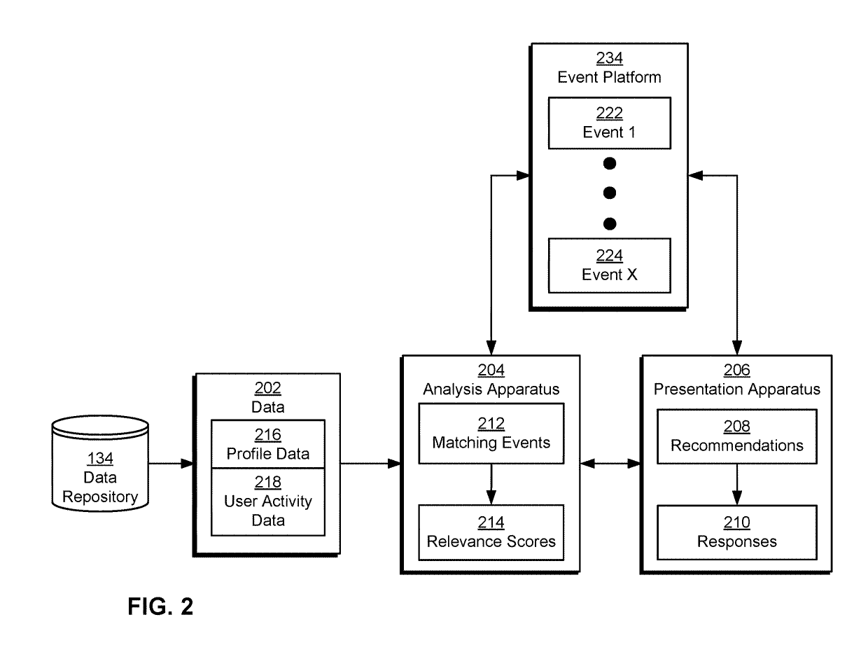

As shown in FIG. 2, data repository 134 and/or another primary data store may be queried for data 202 that includes profile data 216 for users of a social network (e.g., online professional network 118 of FIG. 1), as well as user activity data 218 that tracks the users' activity within and/or outside the social network. Profile data 216 may include data associated with user profiles in the social network. For example, profile data for an online professional network may include a set of attributes for each user, such as demographic (e.g., gender, age range, nationality, location), professional (e.g., job title, professional summary, employer, industry, experience, skills, seniority level, professional endorsements), social (e.g., organizations of which the user is a member, geographic area of residence), and/or educational (e.g., degree, university attended, certifications) attributes.

Profile data 216 may also include a set of groups to which the user belongs, the user's contacts and/or connections, and/or other data related to the user's interaction with the online professional network. Connection information for multiple users may additionally be combined into a graph, with nodes in the graph representing entities (e.g., users, schools, companies, locations, etc.) in the online professional network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of user interaction with one another and/or content associated with the online professional network. For example, the user activity data may be used to track impressions, clicks, likes, dislikes, shares, hides, comments, posts, updates, conversions, and/or other user interaction with content in the online professional network. The user activity data may also track other types of activity, including connections, messages, and/or interaction with groups or events. Like profile data 216, the user activity data may be used to create a graph, with nodes in the graph representing entities and/or content and edges between pairs of nodes indicating actions taken by entities, such as creating or sharing articles or posts, sending messages, connection requests, joining groups, and/or following other entities.

In one or more embodiments, profile data 216 and user activity data 218 are used to match members of the online professional network with events that may improve the development of the members' skills, professional reputation, professional networks, employment prospects, and/or other attributes related to the members' careers or business practices. During such matching, an analysis apparatus 204 may retrieve profile data 216, user activity data 218, and/or other member attributes from data repository 134. For example, the analysis apparatus may obtain a member's location, skills, job title, summary, work experience, company, school, industry, seniority, follows, connections, and/or group memberships from the data repository. The analysis apparatus may optionally supplement some or all of the attributes with the same attributes from other members that are connections, colleagues, classmates, industry peers, and/or otherwise related to the member.

Analysis apparatus 204 may also retrieve event attributes for a set of events (e.g., event 1 222, event x 224) from an event platform 234. For example, the analysis apparatus may use a search tool, application programming interface (API), and/or other communication mechanism with the event platform to query the event platform for events that are within a pre-specified distance (e.g., driving distance) of the member's location. The analysis apparatus may optionally run a separate query for events that exceed the pre-specified distance but have a popularity (e.g., attendance, rating, etc.) that exceeds a threshold. Each query may additionally contain one or more member attributes from data repository 134, such as one or more skills listed in the member's profile. In response to the query or queries, the event platform may provide event locations, titles, descriptions, categories, types, dates, tags, and/or popularities for a set of matching events 212 (i.e., events that match the parameters of the query) to the analysis apparatus. Alternatively, analysis apparatus 204 may retrieve the event attributes from data repository 134 and/or another data-storage mechanism (e.g., a relational database).

After matching events 212 are generated for a given member, analysis apparatus 204 may use profile data 216 and/or user activity data 218 for the member and event attributes for the matching events to calculate a set of relevance scores 214 for the matching events. Each relevance score may represent the relevance of the corresponding event to the member. As a result, the relevance score may be calculated as a measure of similarity, overlap, and/or other commonality between one or more member attributes of the member and the event attributes of the event.

More specifically, one or more skills, job titles, schools, companies, and/or other member attributes of the member and/or the member's network may be selected for use in calculating relevance scores 214. For example, a subset of skills deemed to be most important to the member's current job title, company, and/or industry and/or a subset of the member's most endorsed skills may be selected in determining the relevance of matching events 212 to the member. The importance of the skills may optionally be supplemented with skills that are trending or popular among the member's connection or peers in the online professional network. To improve comparison of the member and event attributes, the member attributes and/or event attributes may be standardized or normalized. For example, skills and/or event attributes of “Java programming,” “Java development,” “Android development,” and “Java programming language” may be standardized to “Java” before the attributes are used to calculate the relevance scores.

Relevance scores 214 may also be affected by social signals associated with the member and/or matching events 212. For example, the relevance score for an event may be influenced by the event's overall popularity, the number of confirmed attendees that are connections of the member, and/or previous attendance of the event (e.g., if the event is regularly scheduled) and/or related events (e.g., events hosted by the same organization or related organizations) by the member and/or the member's network.

Relevance score 214 may then be calculated as a sum and/or other aggregation of components associated with the member and/or event attributes. For example, relevance score 214 may be produced by a mathematical and/or statistical model as a weighted combination of the proximity of the event to the member, the inclusion of a selected skill or other member attribute in the event title or description, and/or the event's popularity with the public and/or the member's connections.

After relevance scores 214 have been calculated for all matching events 212, analysis apparatus 204 may rank the matching events by the relevance scores. For example, the analysis apparatus may order the matching events in descending order of relevance score so that the events that are deemed to be most relevant to the member are at the top of the ranking.

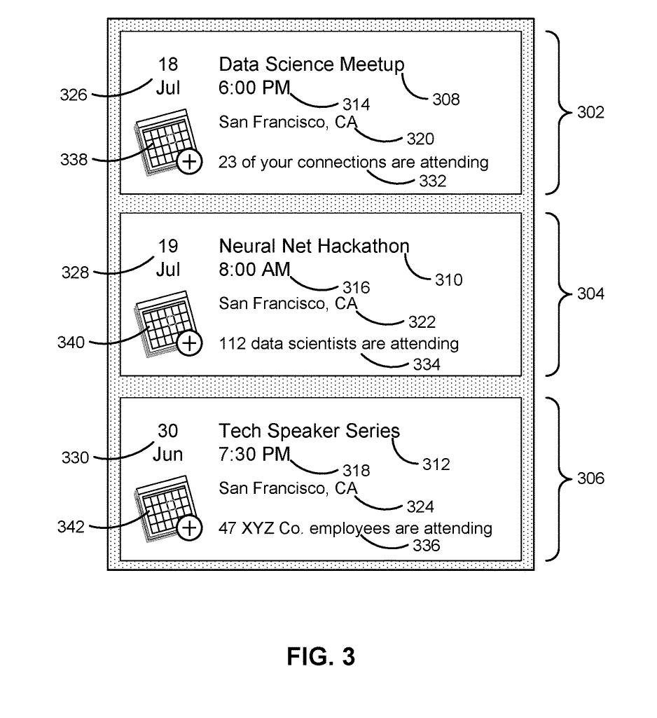

A presentation apparatus 206 may then use relevance scores 214 and/or the ranking from analysis apparatus 204 to output a subset of matching events 212 as recommendations 208 to the member. For example, the presentation apparatus may display, within a graphical user interface (GUI), a pre-specified number of the matching events with the highest relevance scores as the recommendations. The recommendations may be ordered by relevance score, date, number of attendees, and/or another attribute. The recommendations may additionally be displayed to the member within an application (e.g., web application, mobile application, native application, etc.) for accessing the online professional network. The recommendations may also, or instead, be delivered via email, a messaging service, a calendar feature, a user interface for event platform 234, and/or another mechanism for communicating or interacting with the member. Outputting relevant events as recommendations to members of online professional networks is described in further detail below with respect to FIG. 3.

Presentation apparatus 206 may also track the member's responses 210 to recommendations 208. For example, the presentation apparatus 206 may monitor impressions, clicks, calendar updates, upvotes, downvotes, ignores, shares, comments, RSVPs, and/or other interaction with the outputted recommendations and/or corresponding events.

Analysis apparatus 204 may use responses 210 tracked by presentation apparatus 206 to update relevance scores 214 for the member and/or other members of the online professional network. For example, the analysis apparatus may use the member's positive responses (e.g., likes, clicks, RSVPs, etc.) to the recommendations to increase the relevance scores of similar events for the member, the member's connections, and/or other members with similar attributes to the member. Conversely, the analysis apparatus may reduce the relevance scores associated with certain events and/or event attributes if the user responds negatively (e.g., ignores, downvotes, etc.) to those events or event attributes. In another example, the analysis apparatus may aggregate all positive, negative, and/or neutral responses to the same recommendation from multiple members into an overall response to the recommendation. The overall response may then be used as a parameter in calculating subsequent relevance scores for the corresponding event.

In turn, updated relevance scores 214 from analysis apparatus 204 may be used by presentation apparatus 206 to modify recommendations 208. For example, the presentation apparatus may use the updated relevance scores to generate additional recommendations that are better tailored to the member after responses 210 to previous recommendation have been received from the member, the member's connections, and/or other members who are similar to the member.

By matching online professional network members to events that are relevant to the members' professional attributes, the system of FIG. 2 may facilitate the members' pursuit of opportunities related to networking, business, professional development, employment prospects, and/or career guidance. In turn, the system may encourage the members to complete their profiles, interact with other members, and/or engage with the online professional network. At the same time, the recommendations may increase attendance at events hosted on event platform 234, thereby increasing use of the event platform. Finally, the adaptation of the recommendations to the members' preferences based on responses 210 may improve the quality of the recommendations over time and further increase engagement with the online professional network and/or event platform.

Those skilled in the art will appreciate that the system of FIG. 2 may be implemented in a variety of ways. First, analysis apparatus 204, presentation apparatus 206, data repository 134, and/or event platform 234 may be provided by a single physical machine, multiple computer systems, one or more virtual machines, a grid, one or more databases, one or more filesystems, and/or a cloud computing system. Analysis apparatus 204, presentation apparatus 206, and event platform 234 may additionally be implemented together and/or separately by one or more hardware and/or software components and/or layers. For example, analysis apparatus 204, presentation apparatus 206, and/or event platform 234 may be provided as services or features within the online professional network and/or separately from the online professional network.

Second, a number of statistical models and/or techniques may be used to calculate relevance scores 214. For example, the relevance scores may be calculated using a regression model, artificial neural network, support vector machine, decision tree, naïve Bayes classifier, Bayesian network, clustering technique, hierarchical model, and/or ensemble model. Moreover, the same statistical model or separate statistical models may be used to generate the relevance scores for various members, member attributes, connections, and/or groups of members. For example, different versions of the statistical model may be used to assess relevance for different member segments in the online professional network.

FIG. 3 shows an exemplary screenshot in accordance with the disclosed embodiments. In particular, FIG. 3 shows a screenshot of GUI provided by a presentation apparatus, such as presentation apparatus 206 of FIG. 2.

The GUI of FIG. 3 includes a list of recommendations 302-306 of events, which may be displayed within an application or device for accessing an online professional network, event platform, and/or another system with access to event information. As mentioned above, the recommended events may be selected to be relevant to the professional development of a member of an online professional network. For example, the events may be identified as relevant to the industry, job title, summary, skills, seniority, and/or other profile attributes of the member's profile with the online professional network. The relevance of a given event may also be increased when member's connections, colleagues, and/or industry peers are likely to be at the event or have expressed interest in the event (e.g., by saving the event, liking the event, sharing the event, adding the event to a calendar, and/or RSVPing for the event), or if the popularity of the event exceeds a threshold. The events may further be ordered and/or filtered in the recommendations based on the member's distance to the events, the events' relevance to the member, the dates and/or times of the events, the events' popularity, and/or other attributes.

Recommendations 302-306 may include a number of user-interface elements 308-336 containing information related to the corresponding events. For the event represented by recommendation 302, user-interface element 308 provides the title (i.e., “Data Science Meetup”), user-interface elements 314 and 326 specify the respective time (i.e., “6:00 PM”) and date (e.g., “18 July”), user-interface element 320 identifies the location (i.e., “San Francisco, Calif.”), and user-interface element 332 provides attendance information (e.g., “23 of your connections are attending”). For the event represented by recommendation 304, user-interface element 310 includes the title (i.e., “Neural Net Hackathon”), user-interface elements 316 and 328 identify the respective time (i.e., “8:00 AM”) and date (i.e., “19 July”), user-interface element 322 indicates the location (i.e., “San Francisco, Calif.”), and user-interface element 334 includes attendance information (i.e., “112 data scientists are attending”). For the event represented by recommendation 306, user-interface element 312 includes the title (i.e., “Tech Speaker Series”), user-interface elements 318 and 330 specify the respective time (i.e., “7:30 PM”) and date (i.e., “30 June”), user-interface element 324 indicates the location (i.e., “San Francisco, Calif.”), and user-interface element 336 provides attendance information (i.e., “47 XHZ Co. employees are attending”).

As a result, user-interface elements 308-330 may include event attributes of the events, while user-interface elements 332-336 may provide information related to both the events and the online professional network of the user. For example, the attendance information in user-interface element 332 may combine the user's connections in the online professional network with RSVPs for the corresponding event, the attendance information in user-interface element 334 may match the user's job title to attendees at the corresponding event, and the attendance information in user-interface element 336 may match the user's employer to attendees at the corresponding event. By identifying specific groups of attendees at the events, user-interface elements 332-336 may encourage the user to attend the events for reasons such as interacting with his/her connections in person, expanding his/her network, engaging with others in the same field, and/or becoming acquainted with colleagues who work at the same company.

The user may hover over, click, select, and/or otherwise interact with one or more user-interface elements 308-342 in recommendations 302-306 to obtain additional information and/or perform actions related to the corresponding events. For example, the user may select the event title in user-interface element 308, 310, or 312 to navigate to view additional information (e.g., event description, event organizer, event cost, etc.) about the corresponding event and/or RSVP for the event. The user may select the event location in user-interface element 320, 322, or 324 to view a full address of the corresponding event location, access an interactive map containing the event location, and/or obtain directions to the event location. The user may select the attendance information in user-interface element 332, 334, or 336 to view a list of attendees to which the attendance information pertains, connect with the attendees, message the attendees, and/or otherwise engage with the attendees in a social or online professional networking context. Finally, the user may select user-interface elements 338-342 to add the corresponding events to his/her calendar.

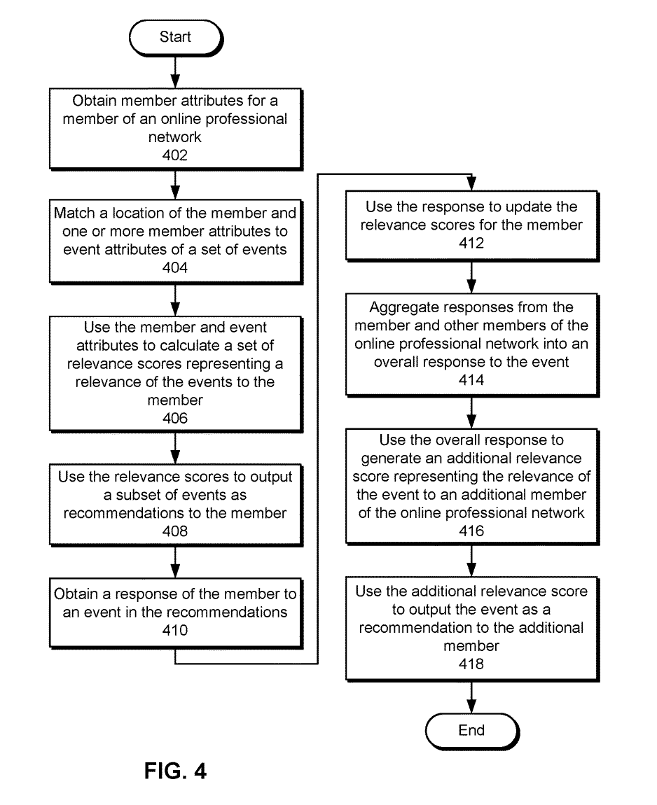

FIG. 4 shows a flowchart illustrating the process of performing skill-based recommendation of events to users in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, member attributes for a member of an online professional network are obtained (operation 402). The member attributes may include explicit and/or inferred characteristics and/or actions of the member. For example, the member attributes may include profile data such as a job title, summary, experience, company, school, industry, seniority, follow, connection, and/or group in the member's profile. The member attributes may also include activity data such as impressions, clicks, likes, dislikes, shares, hides, comments, posts, updates, conversions, and/or other actions performed by the member within the online professional network.

Next, the location of the member and one or more member attributes are matched to event attributes of a set of events (operation 404). For example, an event platform may be queried for event attributes such as event locations, titles, descriptions, categories, types, dates, tags, and/or popularities. The query may specify that the events be within a pre-specified distance of the member's location and that the corresponding event attributes include one or more member attributes (e.g., skills, job title, industry, etc.) of the member and/or the member's connections in the online professional network. The pre-specified distance may optionally be increased or omitted when the popularity of an event exceeds a threshold.

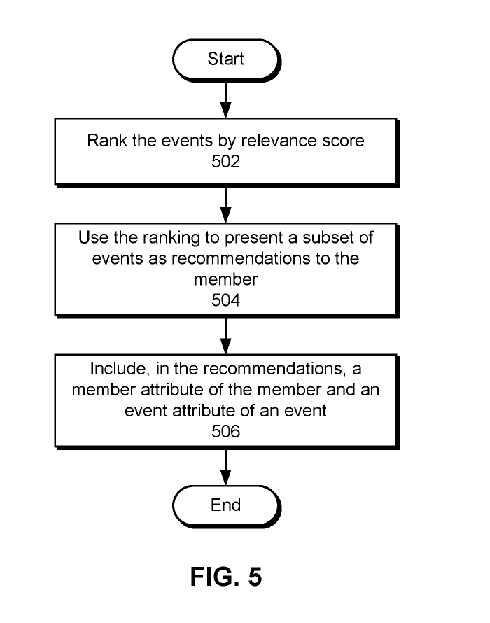

The member and event attributes are also used to calculate a set of relevance scores representing a relevance of the events to the member (operation 406). For example, a mathematical and/or statistical model may be used to calculate the similarity scores as a function of the similarity of the member and event attributes, the popularity of the event, the distance of the event from the member, and/or other criteria. The relevance scores are then used to output a subset of event as recommendations to the member (operation 408), as described in further detail below with respect to FIG. 5.

After the recommendations are outputted, a response from the member to an event in the outputted recommendations is obtained (operation 410). For example, the response may include an impression, click, RSVP, upvote, downvote, comment, ignore, and/or other action taken by the member after the recommendation is displayed and/or otherwise presented to the member.

Next, the response is used to update the relevance scores for the member (operation 412). For example, a positive response from the member to the event may be used to increase the relevance scores for similar events, while a negative response from the member to the event may result in a decrease in the relevance scores for the similar events.

Responses from the member and other members of the online professional network are also aggregated into an overall response to the event (operation 414). For example, the responses may be used to calculate a score representing the overall level of interest or enthusiasm for the event within a member segment represented by the first-degree network, second-degree network, company, field, industry, and/or another attribute of the member. The overall response is used to generate an additional relevance score representing the relevance of the event to an additional member of the online professional network (operation 416), and the additional relevance score is used to output the event as a recommendation to the additional member (operation 418). For example, a positive overall response may increase the additional relevance score, and a negative overall response may decrease the additional relevance score. The additional relevance score may then be used to select or omit the event as a recommendation to the additional member.

FIG. 5 shows a flowchart illustrating the process of outputting events as recommendations to a member of an online professional network in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, the events are ranked by relevance score (operation 502). For example, the events may be ordered in decreasing order of relevance score. Next, the ranking is used to present a subset of events as recommendations to the member (operation 504). For example, a list of the highest ranked events may be displayed and/or otherwise provided as the recommendations to the member. A member attribute of the member and an event of an event is further included in the recommendations (operation 506). For example, the recommendations may include the titles, dates, times, locations, and/or other event attributes of the events. The recommendations may also provide information related to the member's network, such as the number of the member's connections, colleagues, industry peers, and/or skill-based peers who are attending the events.

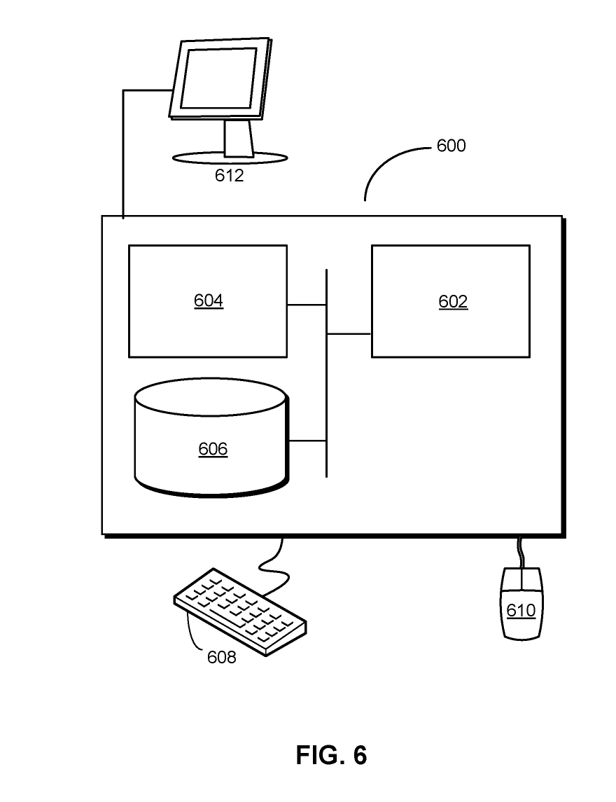

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for performing skill-based recommendation of events. The system may include an analysis apparatus and a presentation apparatus, one or both of which may alternatively be termed or implemented as a module, mechanism, or other type of system component. The analysis apparatus may obtain member attributes for a member of an online professional network. Next, the analysis apparatus may match the location of the member and one or more of the member attributes to event attributes of a set of events. The analysis apparatus may then use the member attributes and event attributes to calculate a set of relevance scores representing a relevance of the events to the member. Finally, the presentation apparatus may use the set of relevance scores to output one or more of the events as recommendations to the member.

In addition, one or more components of computer system 600 may be remotely located and connected to the other components over a network. Portions of the present embodiments (e.g., analysis apparatus, presentation apparatus, data repository, event platform, etc.) may also be located on different nodes of a distributed system that implements the embodiments. For example, the present embodiments may be implemented using a cloud computing system that recommends events that are relevant to the skills or professional development of a set of remote users.

By configuring privacy controls or settings as they desire, members of social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining member attributes for a member of an online professional network;
matching a location of the member and one or more of the member attributes to event attributes of a set of events;
using the member attributes and the event attributes to calculate, by a computer system, a set of relevance scores representing a relevance of the events to the member; and
using the set of relevance scores to output a subset of the events as recommendations to the member.

2. The method of claim 1, further comprising:
obtaining a response of the member to an event in the recommendations; and
using the response to update the relevance scores.

3. The method of claim 2, further comprising:
aggregating the response and other responses to the event from other members of the online professional network into an aggregated response to the event;
using the aggregated response to generate an additional relevance score representing a relevance of the event to an additional member of the online professional network; and
using the additional relevance score to output the event as a recommendation to the additional member.

4. The method of claim 3, further comprising:
filtering the overall response to include responses from connections of the additional member prior to using the overall response to generate the additional relevance score.

5. The method of claim 1, wherein matching the location of the member and the one or more of the member attributes to the event attributes comprises:
obtaining the set of events to be within a pre-specified distance of the location; and
matching the event attributes of the events to the one or more of the member attributes.

6. The method of claim 5, wherein matching the location of the member and the one or more of the member attributes to the event attributes further comprises:
adjusting the pre-specified distance based on a popularity of the events.

7. The method of claim 1, wherein using the set of relevance scores to output the subset of the events as recommendations to the member comprises:
ranking the events by the relevance scores;
using the ranking to present the subset of the events as the recommendations to the member; and
including, in the recommendations, a member attribute of the member and an event attribute of an event in the subset.

8. The method of claim 1, wherein the event attributes comprise at least one of:
an event location;
a title;
a description;
a category;
an event type;
a date;
a tag; and
a popularity.

9. The method of claim 1, wherein the member attributes used to calculate the set of relevance scores comprises at least one of:
a job title;
a summary;
an experience;
a company;
a school;
an industry;
a seniority;
a follow;
a connection; and
a group.

10. The method of claim 1, wherein the member attributes comprise:
a first skill of the member; and
a second skill of a connection of the member.

11. An apparatus, comprising:
one or more processors; and
memory storing instructions that, when executed by the one or more processors, cause the apparatus to:
obtain member attributes for a member of an online professional network;
match the location of the member and one or more of the member attributes to event attributes of a set of events;
use the member attributes and the event attributes to calculate a set of relevance scores representing a relevance of the events to the member; and
use the set of relevance scores to output one or more of the events as recommendations to the member.

12. The apparatus of claim 11, wherein the memory further stores instructions that, when executed by the one or more processors, cause the apparatus to:
obtain a response of the member to an event in the recommendations; and
use the response to update the relevance scores.

13. The apparatus of claim 12, wherein the memory further stores instructions that, when executed by the one or more processors, cause the apparatus to:
aggregate the response and other responses to the event from other members of the online professional network into an overall response to the event;
use the overall response to generate an additional relevance score representing a relevance of the event to an additional member of the online professional network; and
use the additional relevance score to output the event as a recommendation to the additional member.

14. The apparatus of claim 13, wherein the memory further stores instructions that, when executed by the one or more processors, cause the apparatus to:
filter the overall response to include responses from connections of the additional member prior to using the overall response to generate the additional relevance score.

15. The apparatus of claim 11, wherein matching the location of the member and the one or more of the member attributes to the event attributes comprises:
obtaining the set of events to be within a pre-specified distance of the location; and
matching the event attributes of the events to the one or more of the member attributes.

16. The apparatus of claim 15, wherein matching the location of the member and the one or more of the member attributes to the event attributes further comprises:
adjusting the pre-specified distance based on a popularity of the events.

17. The apparatus of claim 11, wherein using the set of relevance scores to output the subset of the events as recommendations to the member comprises:
ranking the events by the relevance scores;
using the ranking to present the subset of the events as the recommendations to the member; and
including, in the recommendations, a member attribute of the member and an event attribute of an event in the subset.

18. A system, comprising:
an analysis module comprising a non-transitory computer-readable medium comprising instructions that, when executed, cause the system to:
obtain member attributes for a member of an online professional network;
match the location of the member and one or more of the member attributes to event attributes of a set of events; and
use the member attributes and the event attributes to calculate a set of relevance scores representing a relevance of the events to the member; and
a presentation module comprising a non-transitory computer-readable medium comprising instructions that, when executed, cause the system to use the set of relevance scores to output one or more of the events as recommendations to the member.

19. The system of claim 18, wherein the non-transitory computer-readable medium of the analysis module further comprises instructions that, when executed, cause the system to:
obtain a response of the member to an event in the recommendations; and
use the response to update the relevance scores.

20. The system of claim 19, wherein the non-transitory computer-readable medium of the analysis module further comprises instructions that, when executed, cause the system to:
aggregate the response and other responses to the event from other members of the online professional network into an overall response to the event;
use the overall response to generate an additional relevance score representing a relevance of the event to an additional member of the online professional network; and
use the additional relevance score to output the event as a recommendation to the additional member.
